(19) United States
(12) Patent Application Publication
(10) Pub. No.: US 2013/0088590 A1
(43) Pub. Date: Apr. 11, 2013

(54) FAR INFRARED IMAGING DEVICE AND IMAGING METHOD USING SAME

(71) Applicants: Kei Shimura, Mito (JP); Naoya Nakai, Hitachinaka (JP)

(72) Inventors: Kei Shimura, Mito (JP); Naoya Nakai, Hitachinaka (JP)

(21) Appl. No.: 13/702,594

(22) PCT Filed: Jul. 19, 2011
(86) PCT No.: PCT/JP2011/066368

§ 371 Date: Dec. 7, 2012

(30) Foreign Application Priority Data
Jul. 27, 2010 (JP) 2010-167681

(51) Int. Cl. H04N 5/33

(52) U.S. Cl. CPC H04N 5/33
USPC 348/135

(57) ABSTRACT

Provided are a far infrared imaging device that illuminates a specimen with far infrared light and detects an image of the specimen, which is a device capable of imaging a specimen speedily without using a high-power light source and without generating damage or a non-linear phenomenon in the specimen as a target to be imaged and a method using the same. A specimen is illuminated with the far infrared light in a line shape or in a shape of a plurality of points arranged in line on the specimen; and an image of the specimen is detected while moving the specimen in a direction perpendicular to the line illuminated by the far infrared light. The far infrared light is emitted by applying pulsed pump light from a femtosecond pulse light source to the far infrared light emission element.

### TECHNICAL FIELD

The present invention relates to a far infrared imaging device to take images of a specimen using light in the far infrared region during testing such as analysis of the component distribution of chemical substances in the specimen or inspection of a dissimilar component or a foreign substance therein, and relates to an imaging method using the same.

### BACKGROUND ART

Electromagnetic waves in the far infrared region from about 25 μm to 4 mm in wavelength are called terahertz waves as well. Since such electromagnetic waves have both properties of penetrability as radio waves and directionality as light and absorption spectra in this region have peaks specific to many substances, they are expected to be effective for identification of substances. Conventionally, however, there are no compact and easy-to-use light sources emitting light in this range, and a detector therefor has to be cooled by liquid helium and so is hard to deal with, and therefore the usage of such electromagnetic waves have been only limited to research purposes.

In 1990s, light sources and detectors using femtosecond laser that are compact and do not require cooling were put into practical use, and research and development for practical use of such electromagnetic waves became popular. Currently general-purpose spectrometry devices based on time-domain spectroscopy are available commercially, and research and development is promoted for application to various fields including security, biosensing, medicine, pharmacy, manufacturing industry and agriculture (see Non-Patent Document 1, for example).

For the application to industry, image acquisition of a specimen is required in many fields. As means for this, a conventionally known method is to place a specimen on a xy stage and repeat measurement while moving the specimen using a point-detecting type spectroscopic analyzer to acquire an image (see Non-Patent Document 1, for example). Further a method of using a two-dimensional arrayed fare infrared photodetector (see Patent Document 1, for example) and a method of acquiring an image using electro-optic crystals and a two-dimensional arrayed CCD camera for visible radiation (see Patent Document 2, for example) are proposed. Another proposed method is to use a one-dimensional arrayed far infrared photodetector (see Non-Patent Document 2, for example).

In the field of industrial applications, speedy image acquisition is required. In the case of a method based on the conventional point-measurement to move a specimen in x and y directions for imaging, however, it takes a few hours to acquire one image, which becomes a factor of delaying the practical realization. For speeding-up, it is necessary to use a high-power light source to irradiate a measurement point with large optical energy so as to shorten the measurement time for one point and further to speed up the scanning in x and y directions. When a measurement point is irradiated with high-power light for point measurement, however, the specimen may be damaged due to heat generated by absorption of optical energy, or a non-linear effect may occur due to the electric field intensity of the light, so that the measurement result may change. On the other hand, a method using a two-dimensional arrayed detector does not need the scanning of a specimen in x and y directions, and therefore is suitable for speeding-up. However, such a method needs irradiation of a large area while maintaining the illuminance of illumination light, which requires a much higher-power light source. When the output of a light source is insufficient, it takes a longer exposure time to acquire an image at one part, thus not leading much effect for speeding-up.

### CITATION LIST

### Patent Literature

Patent Document 1: JP Patent Publication (Kokai) No. 2003-075251 A

Patent Document 2: JP Patent Publication (Kohyo) No. 2000-514549 A

### Non-Patent Literature

Non-Patent Document 1: Handbook of Terahertz Technology, edited by Terahertz technology Forum, pp. 426 to 456, published by NGT corporation on Nov. 29, 2007

Non-Patent Document 2: Michael Herrmann et al., “Multi-channel Signal Recording with Photoconductive Antennas for THz Imaging”, Proc. of 10th IEEE International Conference on THz Electronics (THz 2002), pp. 28 to 31 (2002)

### SUMMARY OF INVENTION

### Technical Problem

It is an object of the present invention to provide a far infrared imaging device that takes an image of a specimen using light in the far infrared region for testing and an imaging method using the device, and to provide a device and a method capable of imaging a specimen speedily without using a high-power light source and without generating damage or a non-linear phenomenon in the specimen as a target to be imaged.

### Solution to Problem

In order to fulfill the aforementioned object, in an embodiment of the present invention, a specimen is illuminated with far infrared light in a line shape or in a shape of a plurality of points arranged in line on the specimen, and an image of the specimen is detected while moving the specimen in a direction perpendicular to the line illuminated by the far infrared light.

### Advantageous Effects of Invention

According to the present invention, a device and a method can be provided capable of imaging a specimen speedily without using a high-power light source and without generating damage or a non-linear phenomenon in the specimen as a target to be imaged.

### BRIEF DESCRIPTION OF THE DRAWINGS

FIG. 1 schematically shows a configuration of a far infrared imaging device.

FIG. 2 schematically shows a configuration of a far infrared light generation element.

FIG. 3 schematically shows a configuration of a far infrared light detection element.

FIG. 4 is a plan view showing the path taken by far infrared light on the surface of a specimen.

FIG. 5 schematically shows another configuration of a far infrared imaging device.

FIG. 6 schematically shows still another configuration of a far infrared imaging device.

FIG. 7 is a plan view showing the path taken by far infrared light on the surface of the specimen.

FIG. 8 schematically shows a further configuration of a far infrared imaging device.

FIG. 9 schematically shows a still further configuration of a far infrared imaging device.

FIG. 10 schematically shows a configuration of a one-dimensional array of point light sources.

FIG. 11 schematically shows another configuration of a one-dimensional array of point light sources.

FIG. 12 schematically shows another configuration of a far infrared imaging device.

FIG. 13 schematically shows still another configuration of a far infrared imaging device.

### DESCRIPTION OF EMBODIMENTS

The following describes embodiments of the present invention, with reference to the drawings.

### Embodiments

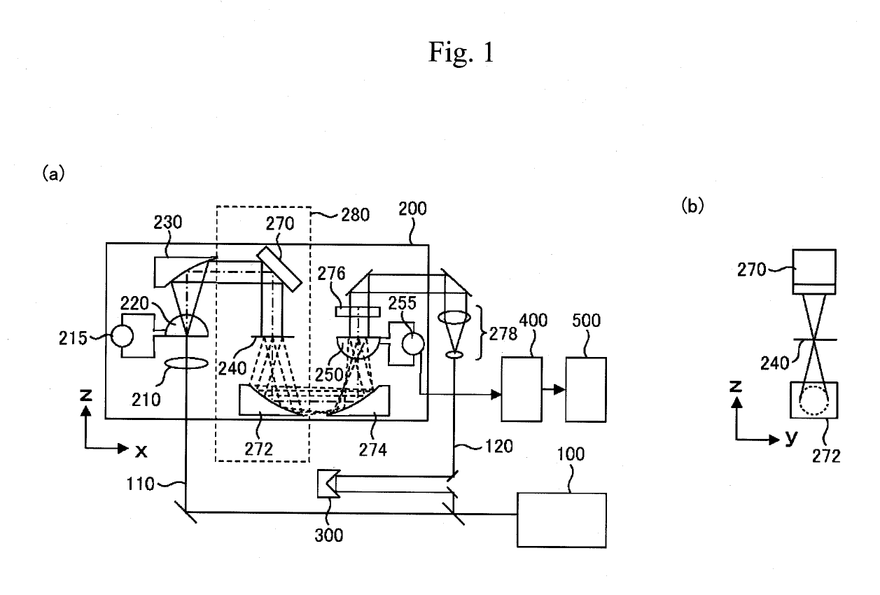

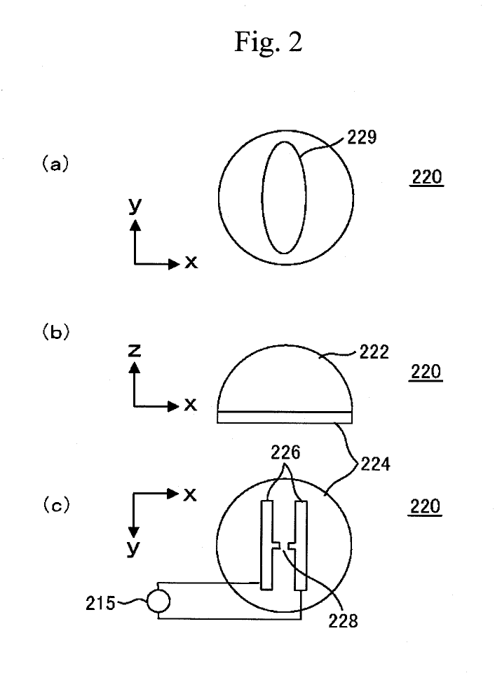

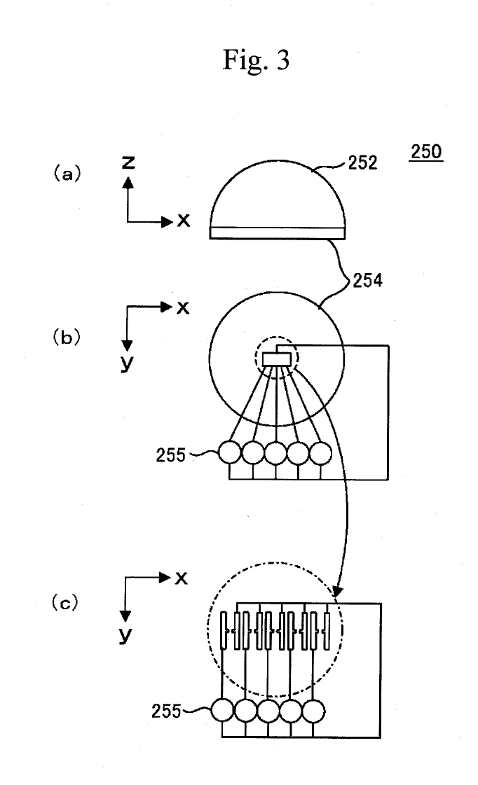

FIG. 1 schematically shows a configuration of a far infrared imaging device. The far infrared imaging device of FIG. 1(a) includes a femtosecond pulse light source 100, an imaging unit 200, an optical delay unit 300, a signal processing unit 400 and a control unit 500. Examples of the femtosecond pulse light source 100 include femtosecond titanium-sapphire lasers having the central wavelength from 780 nm to 800 nm, the pulse width from about 10 femtoseconds to 150 femtoseconds and the repetition frequency from about 50 megahertz to 100 megahertz as well as fiber lasers. Fiber lasers having 1.5 micrometer band also is available for this purpose. Femtosecond pulse light emitted from the femtosecond pulse light source 100 is divided by a beam splitter into pump light 110 used to generate far infrared light and probe light 120 used to detect far infrared light, which pass through an irradiation optical element 210 and a cylindrical lens 276 of the imaging unit 200, respectively, and are applied to a far infrared light generation element 220 and a far infrared light detection element 250, respectively. Bias voltage is applied from a bias power supply 215 to between electrodes of the far infrared light generation element 220 and pulses of the pump light 110 are applied to a part of the gap between the electrodes, whereby current flows through at the part of the gap and far infrared pulse light is emitted. The far infrared light generation element 220 will be described referring to FIG. 2, and the far infrared light detection element 250 will be described referring to FIG. 3.

The illumination optical system used includes an off-axis paraboloid mirror 230 and a cylindrical concave mirror 270, for example. The cylindrical concave mirror 270 used has curvature in the direction perpendicular to the sheet of FIG. 1(a). FIG. 1(b) is a side view of an optical system part 280 indicated with the dotted line of FIG. 1(a) viewed from the right of the sheet, and the illumination light is narrowed on the specimen 240 to the direction perpendicular to the sheet of FIG. 1(a) and is applied in the shape of a line or in the shape of an ellipse.

The specimen 240 is placed on a stage that can move the specimen in three-axis directions of xyz. Preferably this stage enables tilt adjustment of the specimen 240 as needed. The tilt adjustment performed beforehand, which suppresses a positional variation in z direction during scanning in xy directions within the focal depth of the illumination light, enables stable speedy imaging. The light passing through the specimen 240 is guided to the far infrared light detection element 250 via an image formation optical system, whereby an image of the specimen 240 is formed at a photo-receiving face of the far infrared light detection element 250.

The image formation optical system used includes the combination of off-axis paraboloid mirrors 272 and 274, for example. In order to form an image of light in the wide frequency band over several terahertz, a reflective optical system may be used like this. Since chromatic aberration does not occur in principle, image formation characteristics that are uniform and have high resolution can be achieved over the wide frequency band. Further, a plurality of off-axis concave mirrors and convex mirrors may be combined, whereby a wide field of view can be obtained. On the other hand, for the usage whose wavelength band can be limited, an optical system using transmissive optical elements made of silicon or plastic or an optical system including the combination of a reflective optical element and a transmissive optical element may be used. In this way, the optical system to be used may be selected depending on the intended use, whereby design flexibility can increase and the optical system can be made compact and at low cost. Further since terahertz light has a longer wavelength than near-infrared or mid-infrared radiation, it is difficult to secure the resolution compared with these wavelength bands. In order to cope with this problem, the projection magnification of the image formation optical system is set larger than 1 so as to be an expanded projection system. This enables an increase in numerical aperture (NA) on the specimen 240 side without increasing the cost of the image formation optical system so much, and therefore high-resolution imaging can be achieved with an optical system at low cost.

The far infrared light detection element 250 used may be a one-dimensional detector array called a linear sensor. More specifically, a one-dimensional arrayed photoconductive switch or a one-dimensional arrayed micro-bolometer may be used therefor. The example of the far infrared light detection element 250 of FIG. 1 uses a one-dimensional arrayed photoconductive switch. For far infrared radiation detection, the photoconductive switch is irradiated with the probe light 120 in accordance with far infrared light to be detected, and current detected by the photoconductive switch is detected by a current detector 255. The resultant is processed by the signal processing unit 400 including an amplifier, so as to obtain a detected signal. The probe light 120 is applied to the far infrared light detection element 250 via the optical delay unit 300 and an illumination optical element 276. The beam may be shaped by the illumination optical system including 276 and 278 described later in accordance with a region to be detected. In this embodiment, a linear region on the specimen 240 is illuminated, an image of which is formed at the photo-receiving face of the far infrared light detection element 250, and therefore the region to be subjected to signal detection also has a linear shape at the photo-receiving face of the far infrared light detection element 250. Thus, the illumination optical system may use a beam expander 278 that is rotationally symmetric and the cylindrical lens 276 to illuminate a linear region at the photo-receiving face of the far infrared light detection element 250. Alternatively, a beam expander having different beam expansion magnifications between x direction and y direction of FIG. 1 such as a beam expander simply using cylindrical lenses may be used.

The signal processing unit 400 performs Fourier-transformation of a plurality of detected signals that are obtained by changing the amount of delaying by the optical delay unit 300 for each measurement point, thus calculating spectrum data. Spectrum data during the absence of the specimen, which is stored in a storage area of the signal processing unit 400, is set as reference data, and the calculated data is compared with the reference data, whereby absorption spectra are calculated so as to obtain a two-dimensional distribution of the absorption spectra or an image of the absorption spectra, or calculate a two-dimensional distribution of wavelength dependency for complex refractive index. For acquisition of measurement data having a fixed amount of delaying, in order to reduce the influence from background light existing naturally and increase the SN ratio for detection, intensity modulation may be applied to the pump light 110 at the frequency of about 1 kilohertz, and a signal from the far infrared light detection element 250 may be lock-in detected. For the intensity modulation, a chopper not illustrated may be provided in the optical path of the pump light 110, or the bias voltage applied to the far infrared light generation element 220 may be modulated. Further the data acquired while fixing the amount of delaying of the optical delay unit 300 at a constant value may be used as an image.

The signal and data processed by the signal processing unit 400 is sent to the control unit 500. The control unit 500 controls the device as a whole and functions as a user interface. The control unit 500 controls the femtosecond pulse light source 100, the imaging unit 200, the far infrared light generation element 220, a stage on which the specimen 240 is placed and the far infrared light detection element 250 included thereof, the optical delay unit 300 and the signal processing unit 400, and displays the signal and data processed by the signal processing unit 400 on a display.

FIG. 2 schematically shows a configuration of the far infrared light generation element. An example of the far infrared light generation element 220 used may be an element configured by attaching a photoconductive switch 224 to a hemispherical or a super hemispherical lens 222 made of silicon. The photoconductive switch 224 may be one including electrodes 226 formed on a low-temperature grown gallium arsenide substrate, for example. Using the bias power supply 215, bias voltage is applied to the electrodes 226, and a gap 228 of the electrodes 226 is irradiated with pulses of the pump light 110, whereby current flows through the gap 228 and far infrared pulse light is emitted. The far infrared pulse light emitted here desirably has the frequency component in the range from 0.1 terahertz to 100 terahertz or has a part thereof. The far infrared light generation element 220 used may include non-linear optical crystals such as electro-optic crystals and DAS T (4-dimethylamino-N-methyl-4-stilbazolium tosylate), a semiconductor material or the like. The far infrared light emitted from the far infrared light generation element 220 is applied to a linear region on the specimen 240 via the illumination optical system.

In order to illuminate the linear region on the specimen 240 effectively with the wide linear irradiation light described referring to FIG. 1(a), the direction of the current flowing through the gap 228 of the electrodes 226 of the photoconductive switch 224 or the direction of the gap 228 may be adjusted in the direction corresponding to the longitudinal direction of the linear illuminated region on the specimen 240. When current flows through the gap 228 in x direction of FIG. 2, the electric field of the far infrared pulse light emitted therefrom will have an intensity distribution expanded wider in y direction than in x direction as shown with an electric field distribution 229 of FIG. 2(a). Then, irradiated on the specimen 240 via the off-axis paraboloid mirror 230 and the cylindrical concave mirror 270 of the illumination optical system, the effective numerical aperture (NA) for light collection in y direction becomes larger, so that linear region illumination having a thinner width in y direction can be achieved on the specimen 240.

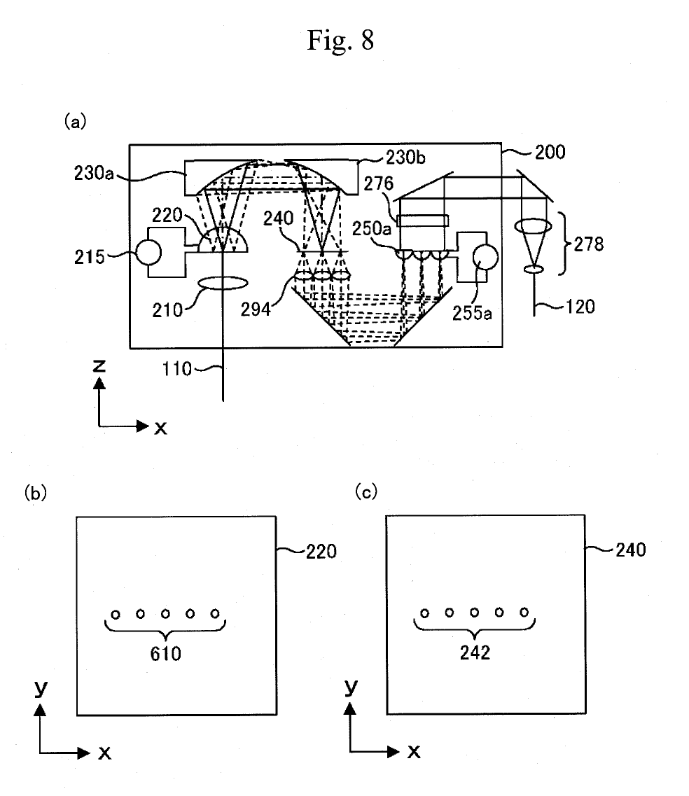

FIG. 3 schematically shows a configuration of the far infrared light detection element. The far infrared light detection element 250 is configured to dispose a one-dimensional arrayed photoconductive switch on a photo-receiving face 254, which is then attached to a hemispherical or a super hemispherical lens 252 made of silicon. Each photoconductive switch is the same as the one exemplified for the far infrared light generation element 220, which may be one including electrodes formed on a low-temperature grown gallium arsenide substrate, for example. Current generated when far infrared light and the probe light 120 are incident is detected by a current detector 255. In this example, one lens 252 is combined with the one-dimensional arrayed photoconductive switch, whereby the distance between the individual photoconductive switches can be made 1 mm or less, and so space sampling at a narrow pitch is enabled on the face of the specimen 240. On the other hand, when there is no need to narrow the pitch of space sampling so much, one dimension array of small lenses of about 1 mm in diameter, for example, may be used as the lens 252 as shown in FIG. 8, 250a, and photoconductive switches each formed for such a lens are aligned to configure the one-dimensional arrayed photoconductive switch. In this case, each photoconductive switch can be arranged precisely at the optical axis of each lens, and therefore the specifications on off-axis aberrations required for each lens can be relaxed, so that designing and manufacturing of the lens can be facilitated, and a difference of detection characteristics between a photoconductive switch around the center of the one-dimensional array and another photoconductive switch at a position closer to the end can be mostly eliminated.

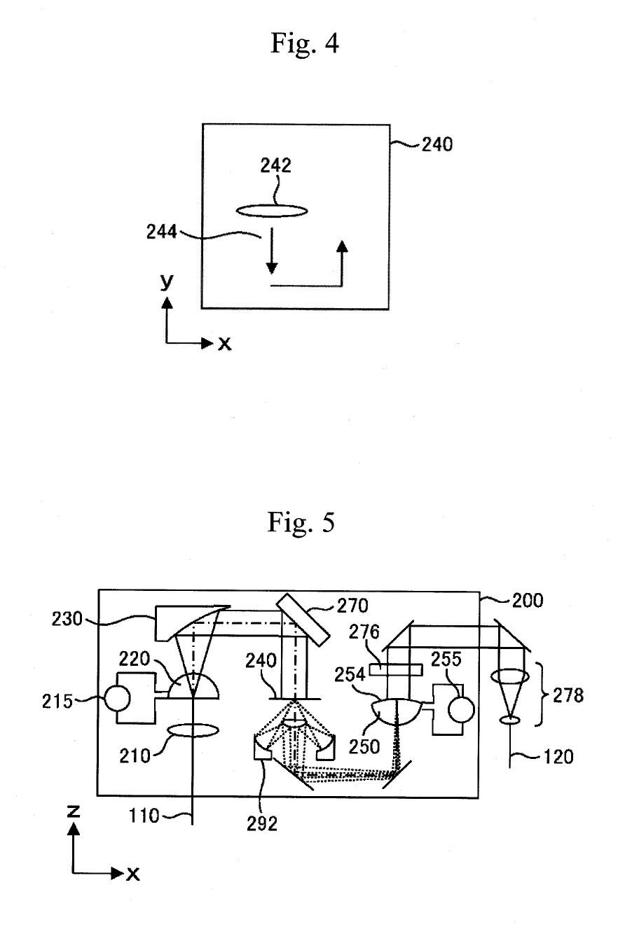

FIG. 4 is a plan view showing the path taken by far infrared light on the surface of the specimen. For acquisition of an image of the specimen 240, the specimen 240 is illuminated at a linear illumination region 242 that is narrow in y direction and long in x direction, and data of the one-dimensional arrayed detector corresponding to the detection region in the illumination region 242 can be acquired through one measurement. While the specimen 240 is moved in y direction perpendicular to x direction and the illumination region 242 is moved in the scanning direction indicated by an arrow 244 on the specimen, data of the one-dimensional arrayed detector is acquired one by one or continuously, whereby data of the area corresponding to the width of the one-dimensional arrayed detector can be obtained. When the region to be imaged on the specimen 240 has a width exceeding this, subsequently the specimen 240 is moved in x direction and a region adjacent to the previously scanned region is scanned again in y direction. By repeating this, imaging in a wider area is enabled.

FIG. 5 schematically shows another configuration of a far infrared imaging device. Since this far infrared imaging device is different from FIG. 1 in the imaging unit 200 only, the drawing shows just the imaging unit 200. An optical system from a far infrared light generation element 220 to a specimen 240 is the same as that shown in FIG. 1. As an image formation optical system forming an image of light passing through the specimen 240 at a far infrared light detection element 250, a reflective image formation optical system element that is rotationally symmetric about the optical axis like a Schwarzschild optical system element 292 as described in US Patent No. 5291339 may be used, for example. While the method using the off-axis paraboloid mirrors 272 and 274 shown in FIG. 1 is simple and is easy to secure a wide field of view, such a method has a problem of difficulty in increase of numerical aperture (NA) and in imaging with high resolution. On the other hand, in the case of a reflective image formation optical system element that is rotationally symmetric about the optical axis, although the center thereof is shielded, numerical aperture NA=0.6 or more can be secured. The far infrared light detection element 250 used may be one configured by attaching a one-dimensional arrayed photoconductive switch to a hemispherical or a super hemispherical lens made of silicon as shown in FIG. 3.

Note here that in order to secure a wide field of view with an optical system element having large numerical aperture (NA) as in this embodiment, the far infrared light detection element 250 preferably has a photo-receiving face 254 that is a curved face such as a spherical face or a cylindrical face. In order to take an image of a wide field of view with an optical system element having large numerical aperture (NA) such as a Schwarzschild optical system element, curvature of filed often becomes a dominant cause of limiting the field of view. Thus, the detection face is curved in accordance with the curvature of field, whereby the curvature of field can be corrected, thus securing wider field of view.

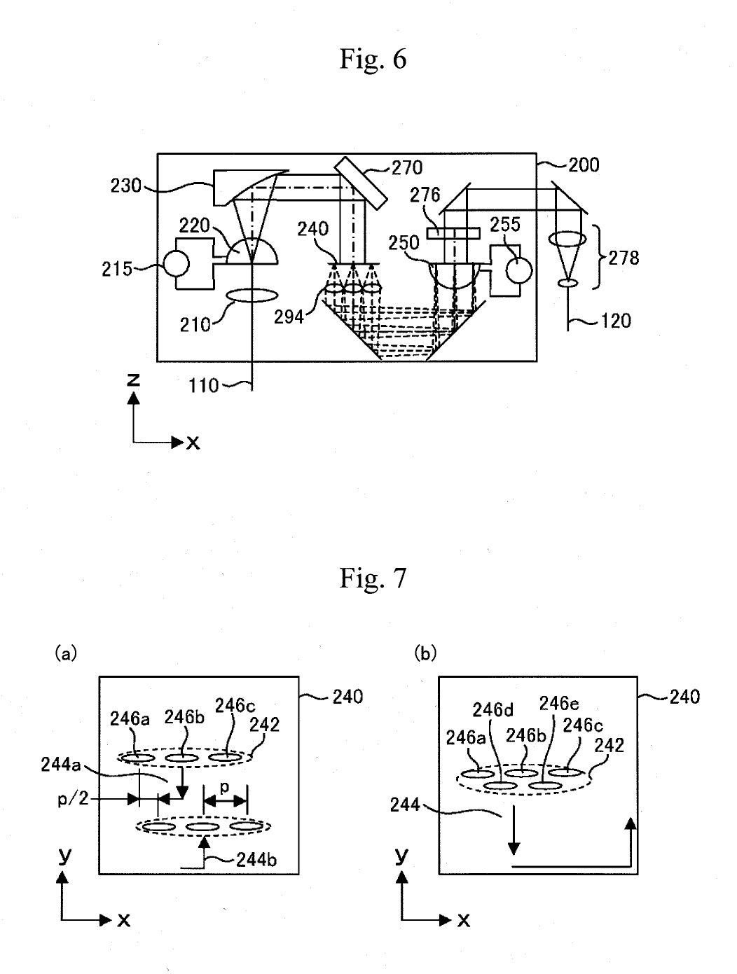

FIG. 6 schematically shows still another configuration of a far infrared imaging device. Since this far infrared imaging device is different from FIG. 1 in the imaging unit 200 only, the drawing shows just the imaging unit 200. An optical system from a far infrared light generation element 220 to a specimen 240 is the same as that shown in FIG. 1. As an image formation optical system forming an image of light passing through the specimen 240 at a far infrared light detection element 250, a one-dimensional arrayed image formation optical system 294 is used. The reflective image formation optical system element that is rotationally symmetric about the optical axis as shown in FIG. 5 is suitable for higher resolution but often has narrow field of view. Imaging of a wide area with narrow field of view requires scanning of illumination light as shown in FIG. 4, and as the number of lines of scanning increases, the imaging time accordingly is extended. Then, in the present embodiment, the image formation optical system is made compact, and a one-dimensional array including the arrangement thereof in parallel is configured. Each image formation optical system may be the reflective image formation optical system element that is rotationally symmetric about the optical axis as shown in FIG. 5 or one including the combination of a plurality of refracting optical elements using a material such as silicon. For imaging of a wideband spectroscopic image, a reflective optical system is suitably used for reduced chromatic aberration. On the other hand, when chromatic aberration is permitted to some extent or when a change of image formation characteristics due to the shielding near the optical axis cannot be ignored, the combination of refracting optical elements made of a material such as silicon may be used. The far infrared light detection element 250 used may be one configured by attaching a one-dimensional arrayed photoconductive switch to a hemispherical or a super hemispherical lens made of silicon as shown in FIG. 3.

FIG. 7 is a plan view showing the path taken by far infrared light on the surface of the specimen. This drawing shows the way of scanning on the face of the specimen 240 when the one-dimensional arrayed image formation optical system shown in FIG. 6 is used. When the image formation optical systems are arranged, if the field of view 246 of each optical system exceeds the width of the optical system, no problem occurs because there is no region where imaging cannot be performed between adjacent optical systems. In the case of optical systems having large numerical aperture (NA) for higher resolution, however, it is often difficult to make the field of view larger than the width of the optical system. As shown in FIG. 7(a), letting the space between the individual optical systems is p, the fields of view 246a, 246b and 246c of these image formation optical systems are aligned with the space p therebetween with reference to the linear illumination region 242 on the surface of the specimen 240, and there is a region between them where imaging cannot be performed. Then, as indicated by the arrow 244a, the region where imaging cannot be performed during first scanning in y direction is imaged by second scanning indicated by the arrow 244b after turning The width of moving in x direction at this time is set at p/2, and then second scanning in y direction is performed. Alternatively, optical systems are arranged at a position displaced in y direction as well so that fields of view are arranged as in FIG. 7(b), thus enabling imaging between the fields of view 246a, 246b and 246c of the image formation optical systems on the first line with the fields of view 246d and 246e of the image formation optical systems on the second line. Thereby, imaging of the linear illumination region 242 as a whole is enabled with one scanning in y direction, whereby the frequency of scanning in y direction can be reduced.

FIG. 8 schematically shows a further configuration of a far infrared imaging device. Since this far infrared imaging device is different from FIG. 1 in the imaging unit 200 only, FIG. 8(a) shows just the imaging unit 200. In this embodiment, a one-dimensional array 610 of point light sources as shown in FIG. 8(b) is used as a far infrared light generation element 220. An illumination optical system leading far-infrared light from the far infrared light generation element 220 to a specimen 240 used may be an imaging optical system forming an image of the plane of the far infrared light generation element 220 at the specimen 240. For instance, the combination of off-axis paraboloid mirrors 230a and 230b may be used. As a result, the illumination region on the face of the specimen 240 will be an illumination region 242 as the points along a line as shown in FIG. 8(c). This is illumination analogous to the linear illumination in a broad sense. Light passing through the specimen 240 forms an image by the image formation optical system on a far infrared light detection element 250a. Since only the region irradiated with illumination light is required to be detected, the one-dimensional arrayed image formation optical system shown in FIG. 6 can be used as the image formation optical system. An image forming optical system with high resolution can be used without consideration given to a region between the individual image formation optical systems where imaging cannot be performed. The drawing shows an example of the far infrared light detection element 250a configuring a one-dimensional arrayed detector where photoconductive switches are arranged, each photoconductive switch including one photoconductive switch attached to a small-diameter silicon lens. Using a detector for detecting dedicated for each image formation optical system, every detector can detect a signal without being influenced by off-axis light focusing characteristics of the lens attached to the detector. Similarly to the case of FIG. 1, the probe light 120 is narrowed linearly for irradiation, whereby a current detector 255a can acquire a detected signal. Herein, the far infrared light detection element 250a used may be one configured by combining a one-dimensional arrayed photoconductive switch with one lens 252 as shown in FIGS. 1 and 3.

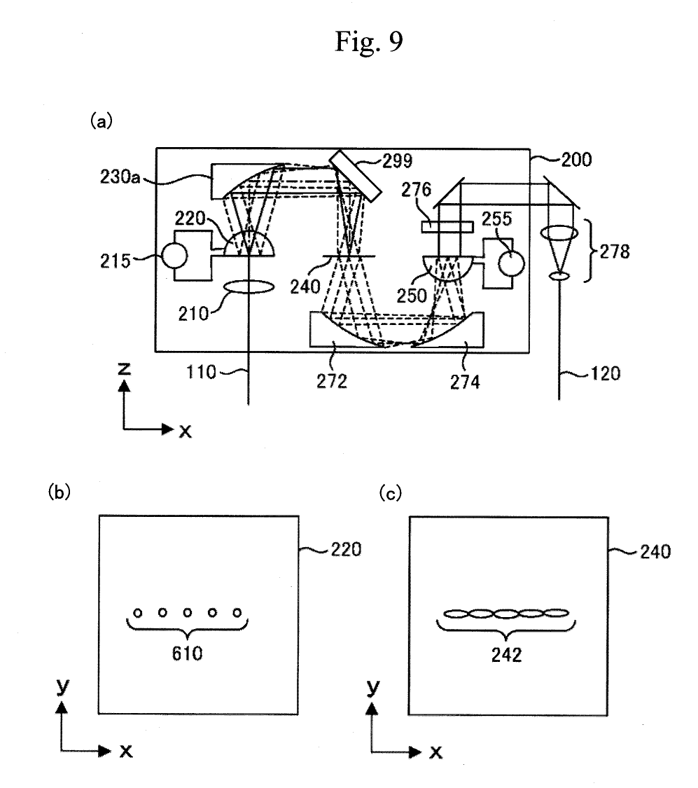

FIG. 9 schematically shows a still further configuration of a far infrared imaging device. Since this far infrared imaging device is different from FIG. 1 in the imaging unit 200 only, FIG. 9(a) shows just the imaging unit 200. This embodiment is a modification example of the configuration shown in FIG. 8(a) where the illumination light on the face of the specimen 240 is distributed as a group of connected points extended in x direction or a group of connected points in x direction as shown in FIG. 9(c). Therefore, the illumination optical system leading far infrared light from a far infrared light generation element 220 to a specimen 240 used may be an optical system such that an image is formed in a cross section in y direction but an image is not formed in a cross section in x direction, or an image is formed with an image forming magnification in x direction larger than an imaging forming magnification in y direction. Light passing through the specimen 240 forms an image by an image formation optical system on a far infrared light detection element 250. As the far infrared light detection element 250, a one-dimensional arrayed detector may be used so as to enable signal detection over the entire region irradiated with the illumination. Widening of the width of the illumination region in x direction can reduce a not-illuminated region between the illumination regions, whereby much data can be acquired by one scanning in y direction. As a result, the frequency of scanning in y direction can be reduced, and the imaging time can be shortened.

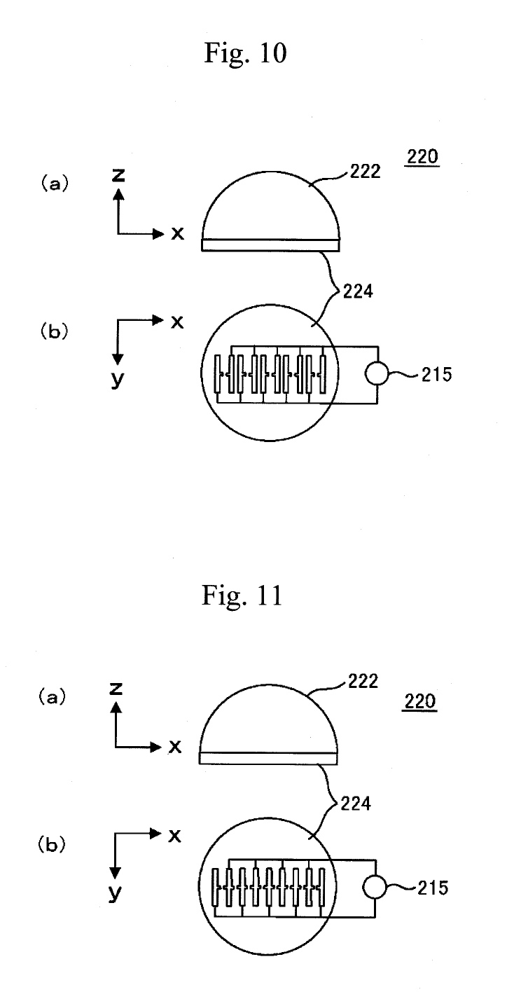

FIG. 10 schematically shows a configuration of the one-dimensional array of point light sources used in the embodiment shown in FIG. 8 or FIG. 9. In this configuration, electrodes of the photoconductive switches shown in FIG. 2 are aligned in a line, which is then attached to a hemispherical or a super hemispherical lens 222 made of silicon. Using a bias power supply 215, the same bias voltage is applied to the plurality of photoconductive switches, whereby, irradiated with pulses of the pump light 110 from a femtosecond laser, far infrared light beams of the same intensity can be generated simultaneously. In order to apply the pulses of the pump light 110 from the femtosecond laser to the individual photoconductive switches effectively, a one-dimensional array of lenses is preferably used for an irradiation optical element 210. Although the same bias voltage is applied to the array of photoconductive switches in this embodiment, a different voltage may be applied for each switch. For instance, when there is a variation in performance among the photoconductive switches, a different voltage may be applied for each, whereby the difference in performance among the photoconductive switches can be corrected, and the outputs of uniform intensity can be obtained.

FIG. 11 schematically shows another configuration of the one-dimensional array of point light sources used in the embodiment shown in FIG. 8 or FIG. 9, which is a modification example of FIG. 10. This embodiment is configured to apply reverse bias to adjacent photoconductive switches. With this configuration, the line of point illumination regions densely arranged on the face of the specimen 240 can be formed, whereby effective illumination is enabled for the case requiring the measurement of discrete points. This embodiment illustrates the example where a one-dimensional array 610 of point light sources is used as a light source to form the line of illumination region 242 as shown in FIG. 8(c) as the illumination region on the face of the specimen 240. Instead, one point light source may be used as the light source and a diffracting type optical element may be used as the illumination optical system, whereby the line of points as the illumination region 242 may be formed on the face of the specimen 240 by diffraction.

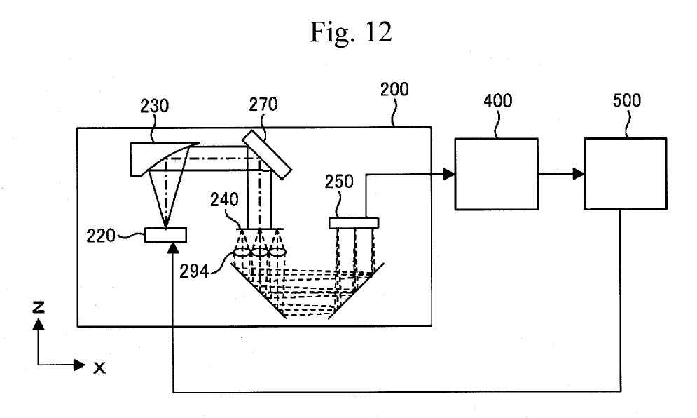

FIG. 12 schematically shows another configuration of a far infrared imaging device. This embodiment does not use the femtosecond pulse light source 100 shown in FIG. 1 to generate and detect far infrared light. For instance, a quantum-cascade laser or a Schottky barrier diode may be used as the far infrared light generation element 220 for such a configuration. As the far infrared light detection element 250, a micro-bolometer array, a Schottky barrier diode array, an extrinsic semiconductor photoconductive detector containing group-3 elements such as aluminum, gallium or indium or group-5 elements such as phosphorus, arsenic or antimony added to silicon or germanium crystals may be used. Since the femtosecond pulse light source 100 is not necessary, the configuration of the optical system can be simplified, and the device cost can be reduced.

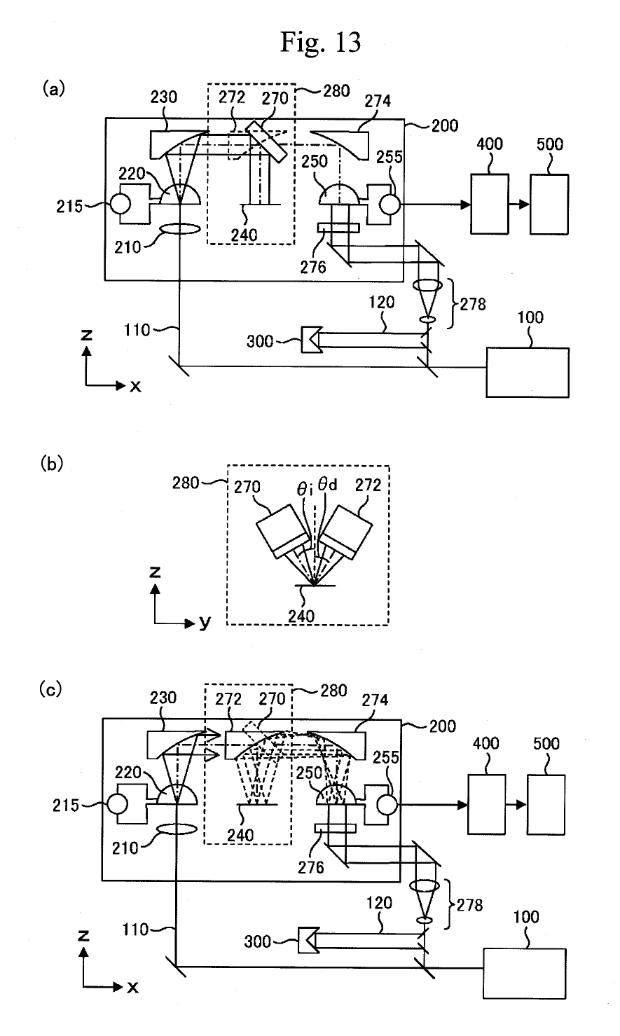

FIG. 13 schematically shows still another configuration of a far infrared imaging device, and has a feature of detecting light reflected from a specimen 240 not detecting light passing through the specimen 240. FIG. 13(b) is a side view of an optical system part 280 indicated with the dotted line of FIG. 13(a) viewed from x direction. Since the illumination optical system and the image formation optical system are overlaid at the same position, the illumination optical system and the image formation optical system are separately illustrated in FIG. 13(a) and FIG. 13(c), respectively, for description.

In order to detect reflected light from the specimen 240, a cylindrical concave mirror 270 of the illumination optical system and an off-axis paraboloid mirror 272 of the image formation optical system are inclined with reference to the normal line (direction parallel to z axis) of the face of the specimen 240 in opposite directions in the yz plane. Far infrared light emitted from a far infrared light generation element 220 is applied to a linear region on the specimen 240 via the illumination optical system. This configuration is different from the embodiment of FIG. 1 in that the optical axis of the optical system for illumination is inclined with reference to the normal line of the face of the specimen 240 by the angle of θi in the yz axes plane as shown in FIG. 13(b). The light reflected from the face of the specimen 240 is guided to the far infrared light detection element 250 via the off-axis paraboloid mirror 272 of the image formation optical system, and an image of the face of the specimen 240 is formed on the face of the far infrared light detection element 250. The off-axis paraboloid mirror 272 of the image formation optical system has an optical axis that is inclined with reference to the face of the specimen 240 in the yz plane by the angle of θd. For imaging based on absorption spectra, specular reflection is desirably detected, and therefore θi=θd is preferable. On the other hand, for the usage to avoid specular reflection and detect scattering light, θi>θd or θi<θd is preferable. In this way, the configuration detecting reflective light enables imaging of a substance with low transmittance or imaging of a substance having the layer structure inside.

As stated above, according to embodiments of the present invention, a far infrared imaging device that takes an image of a specimen using light in the far infrared region for inspection and an imaging method using the device are provided, and a device and a method capable of imaging a specimen speedily without using a high-power light source and without generating damage or a non-linear phenomenon in the specimen as a target to be imaged can be obtained.

### REFERENCE SIGNS LIST

100: Femtosecond pulse light source
110: Pump light
120: Probe light
200: Imaging unit
210: Irradiation optical element
220: Far infrared light generation element
222, 252: Lens
230, 272, 274: Off-axis paraboloid mirror
240: Specimen
250: Far infrared light detection element
254: Photo-receiving face
270: Cylindrical concave mirror
292: Schwarzschild optical system element
300: Optical delay unit
400: Signal processing unit
500: Control unit

1. A far infrared imaging device that irradiates a specimen with far infrared light and detects an image of the specimen, comprising:
a far infrared light emission element that emits the far infrared light;
an illumination optical system that makes the far infrared light in a line shape or in a shape of a plurality of points arranged in line on the specimen; and
an image formation optical system that detects the image while moving the specimen in a direction perpendicular to the line illuminated by the far infrared light.

2. The far infrared imaging device according to claim 1, wherein the far infrared light is emitted by applying pulsed pump light from a femtosecond pulse light source to the far infrared light emission element.

3. The far infrared imaging device according to claim 2, wherein the far infrared light emission element comprises a photoconductive switch, and current flows through the photoconductive switch in a direction corresponding to the longitudinal direction of the linear illuminated region on the specimen.

4. The far infrared imaging device according to claim 1, wherein the far infrared light emission element is a quantum-cascade laser.

5. The far infrared imaging device according to claim 1, wherein the far infrared light emission element is a Schottky barrier diode.

6. The far infrared imaging device according to claim 1, wherein the image formation optical system comprises a far infrared light detection element using a one-dimensional array of photoconductive switches.

7. The far infrared imaging device according to claim 3, wherein the image formation optical system comprises a far infrared light detection element using a one-dimensional array of photoconductive switches.

8. The far infrared imaging device according to claim 1, wherein the image formation optical system comprises a Schwarzschild optical system element.

9. The far infrared imaging device according to claim 1, wherein the image formation optical system comprises combination of off-axis paraboloid mirrors.

10. The far infrared imaging device according to claim 1, wherein the image formation optical system is a projection optical system having a magnification larger than 1.

11. An imaging method using a far infrared imaging device that irradiates a specimen with far infrared light and detects an image of the specimen, the method comprising the steps of:
illuminating the specimen with the far infrared light in a line shape or in a shape of a plurality of points arranged in line on the specimen; and
detecting the image while moving the specimen in a direction perpendicular to the line illuminated by the far infrared light.

12. The imaging method according to claim 11, wherein the far infrared light is emitted by applying pulsed pump light from a femtosecond pulse light source to a far infrared light emission element.

13. The imaging method according to claim 12, wherein the far infrared light emission element comprises a photoconductive switch, and the far infrared imaging device used is configured to let current flow through the photoconductive switch in a direction corresponding to the longitudinal direction of the linear illuminated region on the specimen.

14. The far infrared imaging device according to claim 1, wherein the image formation optical system comprises a far infrared light detection element with a one-dimensional detector array formed on a curved surface.
